(19) United States
(12) Patent Application Publication
(10) Pub. No.: US 2006/0045687 A1
(43) Pub. Date: Mar. 2, 2006

(54) Multipurpose all-terrain vehicle

(76) Inventor: Michael Finley, West Chester, PA (US)

Correspondence Address: WERNER & AXENFELD, LLP, P. O. BOX 1629, WEST CHESTER, PA, 19380, US

(21) Appl. No.: 11/126,580

(22) Filed: May 11, 2005

Related U.S. Application Data
(60) Provisional application No. 60/585,928, filed on Jul. 8, 2004.

(51) Int. Cl. B60P 9/00

(52) U.S. Cl. 414/462

(57) ABSTRACT

A multipurpose all-terrain vehicle includes an elevated platform having a frame on which it may support a lifting system, a propulsion system, a power source, a control mechanism, a secondary height adjustable platform, a tow hitch, a plow, and other suitable accessories. Centered directly underneath the elevated frame is an arcuate space configuration. The elevated platform may be supported by arches that rest on a wheeled or tracked propulsion system. The vehicle is configured to straddle, lift, and transport heavy loads underneath the elevated platform and maneuver in all types of terrain without damaging delicate terrain or subterranean objects. The multipurpose vehicle is especially suited for use by arborists, landscape professionals, and other professionals, in a suburban or urban environment. The vehicle is inexpensive, lightweight, compact, and highly maneuverable.

### CROSS-REFERENCE TO RELATED APPLICATIONS

The present patent application claims benefit of U.S. Provisional Application Ser. No. 60/585,928 filed on Jul. 8, 2004. The content of the aforementioned application is fully incorporated by reference herein.

### TECHNICAL FIELD

This invention relates generally to a self-propelled all-terrain vehicle able to perform a multitude of load transferring tasks, as well as other secondary and tertiary tasks.

### BACKGROUND

Most machines that lift and carry loads are designed to bear the weight of the load in the front or back of the machine. For example, timber machines used to lift and carry timber usually use a lifting mechanism positioned on the front or back of the machine and require counter balancing designs to offset the weight of a lifted load. These machines tend to be very heavy and typically can only lift one half of their own weight exacerbating the need to use heavy equipment for even moderate weighted loads.

In a forest or a lumber yard environment, the weight of such machines may not be a concern to the terrain, but in other environments, such as suburban lawns and golf courses, heavy machinery tends to damage delicate terrain. For example, the lightest of swing loaders typically weigh in excess of 19,000 lbs and log skidders in excess of 10,000 lbs. The weight of such heavy equipment causes high soil compaction that in turn leaves aesthetically unappealing marks on manicured lawns and is destructive to tree root systems and subterranean objects frequently present in a suburban setting such as septic systems, pipes, electrical lines, cables, optical systems, and sprinkler systems.

Moreover, because of their large size and design primarily for forestry applications, access may be denied in tight spaces or small landscapes, or where damage to the terrain needs to be minimized. Maneuverability of heavy machinery can also be limited especially over difficult and uneven terrain. Furthermore, transporting heavy equipment from site-to-site typically requires tractor-trailer like trucks and heavy duty trailing equipment, which is costly and inconvenient to transport.

Another drawback of such machines is that they are generally limited to performing a specific task, such as cutting, lifting, loading, moving, transporting, plowing, digging, or skidding. To perform more than one of these operations typically requires the use of several different machines. For example, land maintenance, such as removal of trees or logs, on golf courses or suburban landscapes, typically involves the use of several pieces of large and expensive equipment. That is, arborists and landscape professionals generally require separate pieces of equipment to perform routine tree work on a job site; e.g., equipment to skid a fallen tree, swing loaders to lift cut logs, and trucks and trailers for removal of debris. Besides the high costs associated with purchasing and maintaining several different pieces of equipment, usually the equipment is designed for forestry applications and is not well suited for more delicate suburban or urban environments.

Accordingly, there is a lack of an inexpensive and single piece of equipment that contains elements to perform all of the functions required by arborists, landscape professionals, and other professionals, especially suited for a suburban or urban environment.

### SUMMARY

Described herein is a multipurpose all-terrain vehicle able to perform a myriad of tasks on a single platform. In one implementation, the multipurpose all-terrain vehicle comprises an elevated platform having a frame on which it may support a lifting system, a propulsion system, a power source, a control mechanism, a secondary height adjustable platform, a tow hitch, a plow, and other suitable accessories.

Centered directly underneath the elevated frame is an arcuate space configuration. The elevated platform may be supported by arches that rest on a wheeled or tracked propulsion system. As a result of using an elevated platform with an arcuate space configuration, the vehicle is configured to straddle, lift, and transport heavy loads underneath the elevated platform.

In one implementation, the lifting system includes a mechanical lever includes a center lifting boom powered by hydraulic pump. The lifting boom includes a hydraulic piston, which causes the boom to lift up and down. Attached to the lifting boom are tongs suspended from the underside of the vehicle that engage, lift and center the load inside the arcuate space configuration that defines the belly of the vehicle. The tongs are free moving and pull from different angles, which permit the load to center itself. It will be appreciated that instead of tongs, a strap, a hook, chain, or other attachment mechanism could be used to secure, lift and center loads.

In one implementation, the lifting system may also include one or more winches mounted on the back and/or front of the vehicle and an extendable lifting boom attached to the rear of the vehicle. For example, on the back of the vehicle a winch cable travels to a rear lifting boom through a block and pulley. This winch can be used to lift, pull, push, and drag loads from the back of the vehicle. Additionally, the rear lifting boom also enables the vehicle to lift loads to different levels such as when transferring a load from the ground to a truck or landing. A secondary cable and winch mounted to the front of the vehicle can be used to raise and lower the rear lifting boom, although the rear lifting boom can be raised and lowered by other means. Additionally, the rear lifting boom can be removed or stored flush with framing of the elevated platform.

Typically, the propulsion system includes a tire or track attached directly to each support member of an arch or arches supporting the elevated platform eliminating the need for axles and providing for the arcuate space configuration. The vehicle's propulsion system may be powered by a diesel motor and a hydraulic pump, which turns four separate hydraulic motors attached to the tires or tracks. Propulsion and turning of the tires or tracks (front and/or rear) allow the vehicle to steer. Steering can be controlled from a steering mechanism, such as levers or a steering wheel, located on the elevated platform. However, steering can also be controlled remotely such as through a wired or wireless remote control system.

In one implementation the multipurpose all-terrain vehicle's four tires are not flush with the vehicle and are protected by design arches. Large tractor tires may be used, such as a ten-ply tractor tire; however, it is appreciated that other tires may be used.

In one implementation, the multipurpose all-terrain vehicle contains a pivot pin located at front and rear arches that permit the front/rear wheels to pivot on rough terrain.

In certain situations, by using the winch or winches attached to the fore and aft of the vehicle, as described above, it is possible to move loads without engaging the propulsions system underneath the elevated platform. This eliminates the need over extremely delicate terrain for the tires/tracks to self-propel causing the tires/tracks to possibly dig-in and damage the terrain or subterranean objects.

In yet another implementation, the multipurpose all-terrain vehicle may include a secondary height adjustable platform which may be integral with the elevated frame or attached thereto. The secondary height adjustable frame may be used as a portable scaffolding to elevate a person higher into trees for trimming and pruning, or be used near a house for power washing or painting, etc.

In one implementation, a plow may also be attached to the front or rear of the vehicle enabling clearing for shrubbery, light earth excavation, snow removal, and other possible pushing/excavating. In one implementation, the multipurpose all-terrain vehicle contains towing means by a tow bar and trailer hitch that attach or detach from the multipurpose all-terrain vehicle. In yet another implementation, the multipurpose all-terrain vehicle may be used to tow trailers, or stump grinders.

In one implementation, the load carrying ability may be expanded by securing a net or metal box beneath the elevated main frame platform to the center lifting boom. In this implementation, the multipurpose all-terrain vehicle can be used to safely transport cement, gravel, bricks, or other heavy, loose materials within the arcuate space configuration of the vehicle.

In yet another implementation, the multipurpose all-terrain vehicle also provides easy access to the elevated main frame platform by way of a step ladder.

The multipurpose all-terrain vehicle is particularly useful by arborist and landscapers to lift, straddle, and transport loads, such as logs, fallen trees, and stumps, as well as perform a myriad of other applications, without damaging delicate lawns or subterranean objects. The innovative multipurpose all-terrain vehicle described herein can straddle and position the weight of a load directly underneath the vehicle. This helps to distribute the weight of a load throughout the vehicle in a plane parallel with the ground and eliminates the need for heavy counterbalancing structures associated with conventional machines that tend to lift and carry loads from the front or back. As a result the innovative multipurpose all-terrain vehicle may be constructed with a lighter structure (at least six times lighter) than a single purpose machine, such as a swing loader, able to lift and carry the equivalent load.

Moreover, due to the unique construction of the innovative all-terrain vehicle, it is able to lift extremely heavy loads of up to twice its own weight over any terrain, including uneven or swampy terrain. In certain situations, by skidding its load, the vehicle can carry up to three times its weight. For example, by lifting one end of a log (or some other type of load) off-center, and skidding the log on the ground, it is possible to increase the load capacity to three times the vehicle's own weight, in sharp contrast to most conventional machines typically limited to carrying only half of their own weight. Thus, the multipurpose all-terrain vehicle described herein is much lighter than equivalent load carrying machines and is able transport a heavy load over delicate lawn turf and uneven terrain with minimal soil compaction. The vehicle's low soil compaction is aesthetically appealing because the vehicle leaves little to no markings on the lawn, and does not result in destruction to the turf, tree root systems or subterranean objects. Likewise, the vehicle may be configured to be smaller than a compact car in terms of its overall footprint, enabling it to maneuver off-road and in tight spots.

Further details and advantages of the multipurpose all-terrain vehicle will become apparent with reference to the accompanying drawings and the following detailed description.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 is a side view of an innovative multipurpose all-terrain vehicle.

FIG. 2 is identical to FIG. 1, but shows the vehicle straddling and transporting a load.

FIG. 3 is an anterior view of the vehicle including the load from FIG. 2 engaged therein.

FIG. 4 is a rear perspective view of the vehicle engaged in straddling and transporting a load.

FIG. 5 is a rear perspective of view the vehicle lifting a load from the rear of the vehicle for transport to a truck (shown in FIG. 9) or landing.

FIG. 6 shows a removable tow bar and trailer hitch attached to the vehicle.

FIG. 7 shows a latch used to allow the tow bar to be removed or secured to a wheel base of the vehicle.

FIG. 8 illustrates one of the many uses of the vehicle, in which the vehicle includes an adjustable secondary platform such as a portable scaffold.

FIG. 9 shows a side view of the posterior end of the vehicle with the winch and hook engaged in transferring a load to or from a second vehicle.

FIG. 10 is a rear perspective view of the vehicle showing how a rear lifting boom may be lowered or raised by the use of a cable from the front of the vehicle.

### DETAILED DESCRIPTION

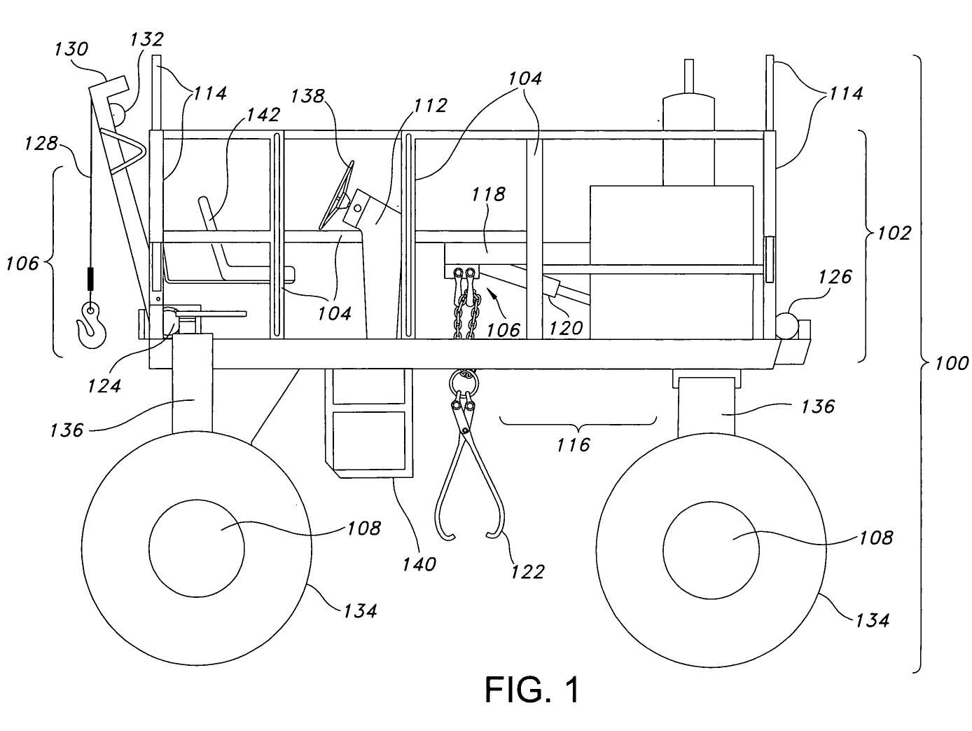

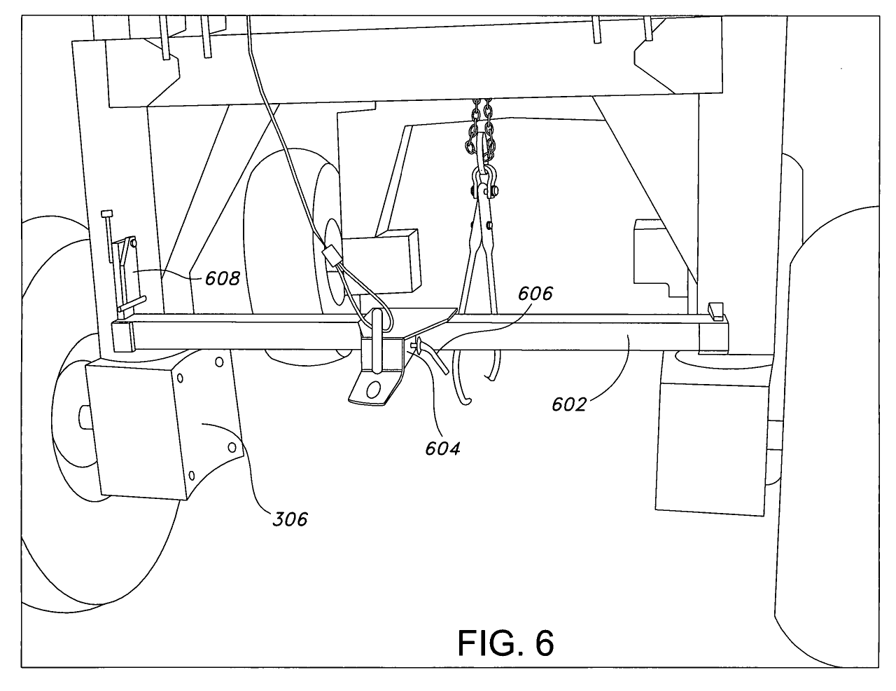

FIG. 1 presents a side view of an innovative multipurpose all-terrain vehicle 100. The vehicle 100 includes an elevated platform 102 having an interconnected frame 104 on which it may support a lifting system 106, a propulsion system 108, a power source 110, a control mechanism 112, a secondary height adjustable platform 114, a tow hitch (see FIG. 6), a plow (not shown), and other suitable accessories (not shown). Centered directly underneath the elevated platform 102 is an arcuate space configuration 116, that defines the belly of the vehicle and which shall be explained in more detail below. As a result of using an elevated platform 102 with an arcuate space configuration 116, the vehicle 100 is configured to straddle, lift, and transport heavy loads underneath the elevated platform 102.

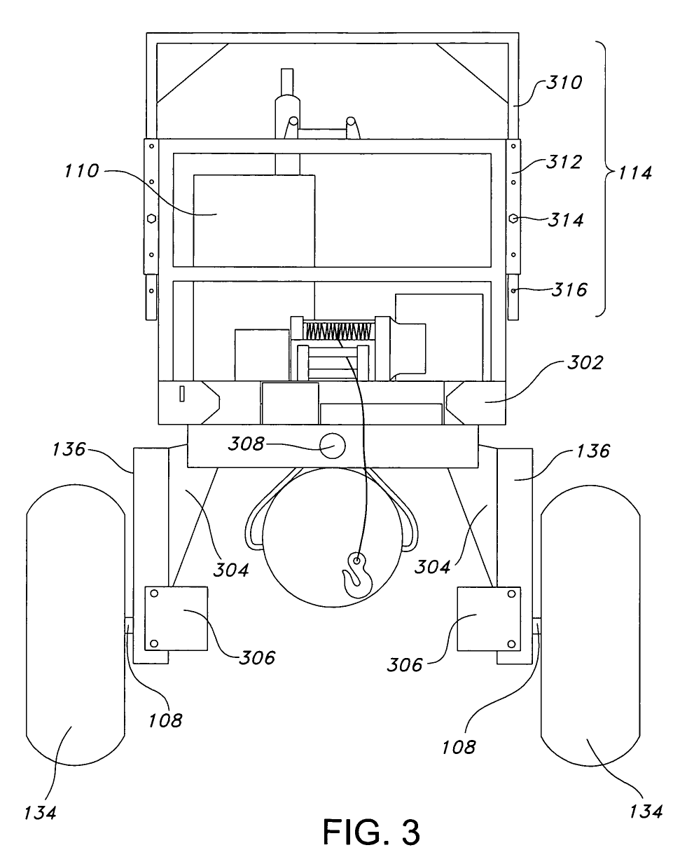

In one implementation, the lifting system 106 includes a center lifting boom 118 powered by a hydraulic pump (See 302 in FIG. 3). The lifting boom 118 includes a hydraulic piston 120, which causes the boom 118 to lift up and down. Attached to the center lifting boom 118 are tongs 122 suspended from the underside of the vehicle 100 that engage, lift and center the load inside the arcuate load carrying space 116 of the vehicle 100. The tongs 122 are free moving and pull from different angles, which permit the load to center itself.

It will be appreciated that instead of tongs, a strap, a hook, chain, or other attachment mechanism could be used to secure, lift and center loads. Additionally, the load carrying ability may be expanded by securing a net (not shown) or box (not shown) beneath the elevated main frame platform 102 to the center lifting boom 118. In this implementation, the multipurpose all-terrain vehicle can be used to safely transport cement, gravel, bricks, or other heavy, loose materials within the arcuate space configuration of the vehicle 100.

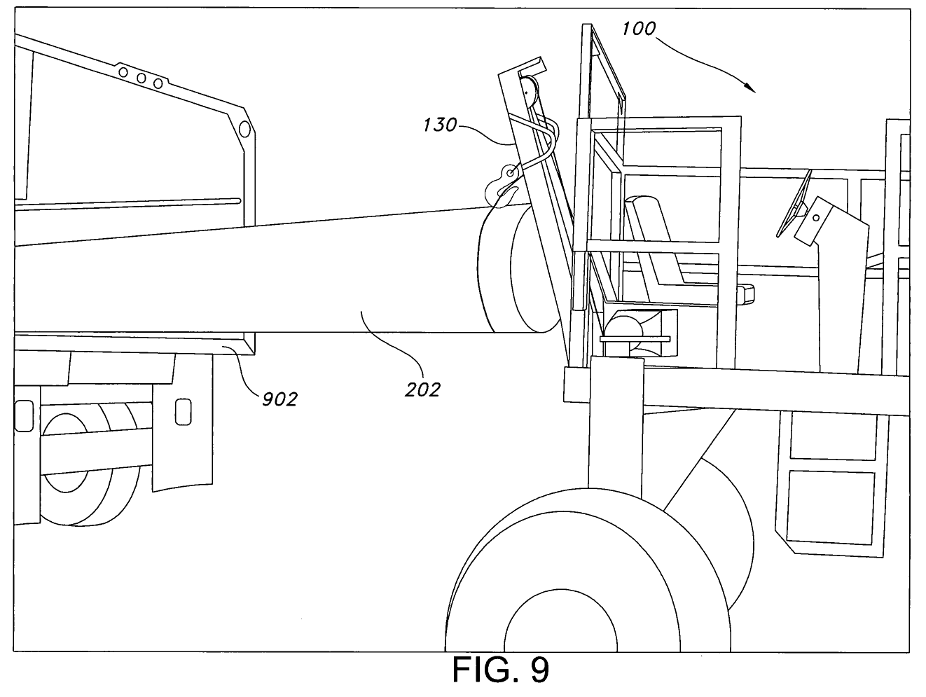

In one implementation, the lifting system 106 may also include one or more winches 124/126 mounted on the back and/or front of the vehicle, respectively. For example, on the back of the vehicle a cable 128 of a rear winch 124 travels up an extendable rear lifting boom 130 and is diverted down through a pulley 132. Alternatively, a snatch-block (not shown) or other guide member for the cable 128 could be used. The winch 124 and cable 128 can be used to lift, pull, push, and drag loads from the back of the vehicle. Additionally, the extendable rear lifting boom 130 also enables the vehicle to lift loads to different levels such as when transferring a load from the ground to a truck (FIG. 9) or landing.

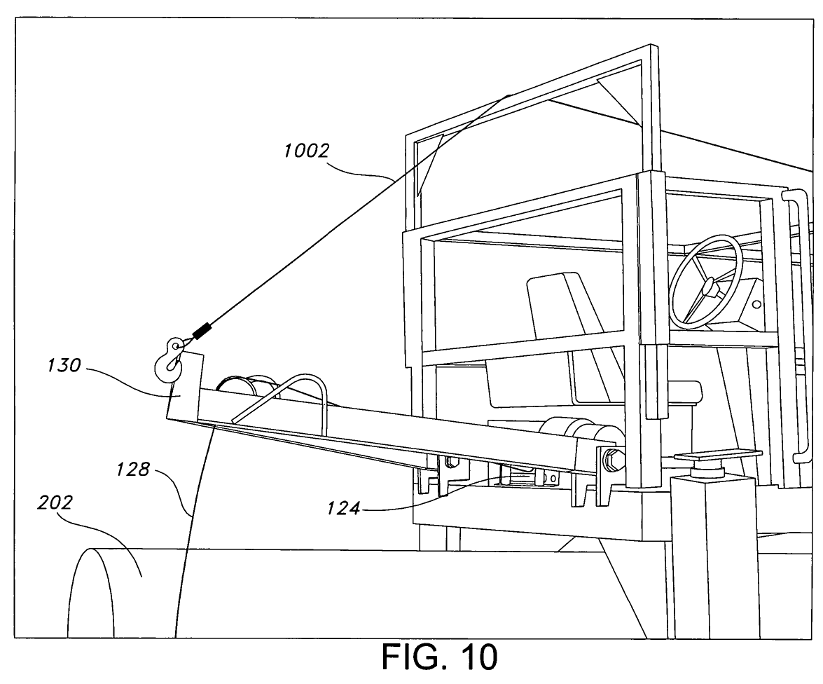

A front cable can be connected from winch 126 to the extendable rear lifting boom 130 as illustrated in FIG. 10. This enables the front winch 126 to control raising and lowering the extendable rear lifting boom 130. Alternatively, the rear lifting boom 130 can be raised and lowered by other mechanism, such as an independent hydraulic pump. Additionally, the rear lifting boom 130 can be removed or stored flush with the interconnected frame 104 associated with the elevated platform 102.

Still referring to FIG. 1, the propulsion system 108 includes a tire 134 or track (not shown) attached directly to each support member 136. Each support member 136 forms part of an arch that supports the elevated platform 102 eliminating the need for axles and providing for the arcuate space configuration 116. The arches shall be described in more detail with reference to FIG. 3 below.

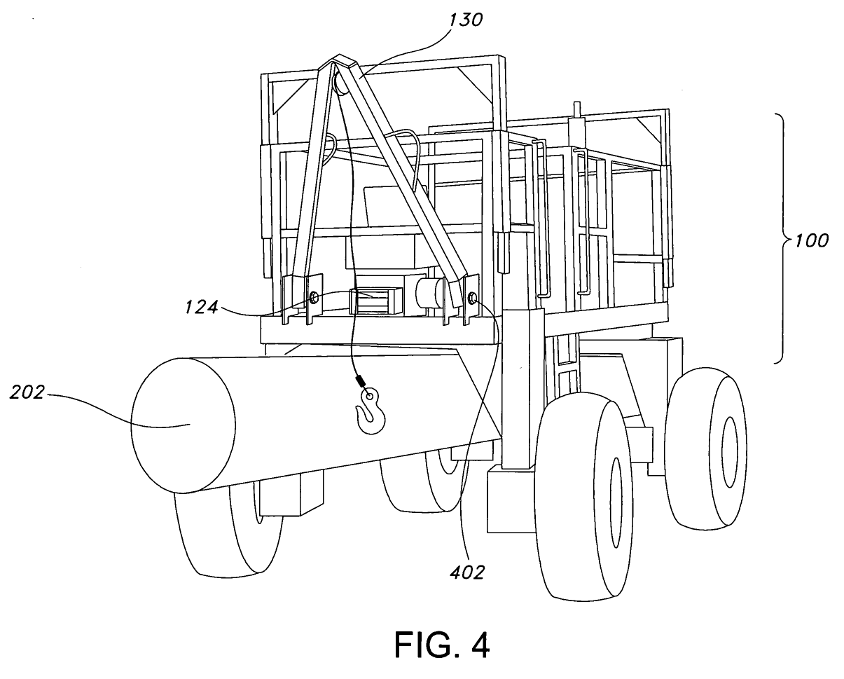

In one implementation, the multipurpose all-terrain vehicle's four tires are not flush with the vehicle and are protected by design arches (shown in FIGS. 3 and 4). Large tractor tires 140 may be used, such as a ten-ply tractor tire; however, it is appreciated that other tires may be used. Steering of the vehicle can be controlled from a control mechanism 112 such as levers (not shown) or a steering wheel 138, located on the elevated platform 102. However, steering can also be controlled remotely such as through a wired or wireless remote control system (not shown).

Referring back to FIG. 1, in certain situations, by using the winch 124 or winches 126 attached to the fore and aft of the vehicle, as described above, it is possible to move loads without engaging the propulsions system 108 underneath the elevated platform 100. This eliminates the need for the tires/tracks to self-propel causing the tires/tracks to possibly dig-in and damage delicate terrain or subterranean objects.

In one implementation, the multipurpose all-terrain vehicle 100 also provides easy access to the elevated main frame platform 102 by way of a step ladder 140.

In yet another implementation, the multipurpose all-terrain vehicle 100 also provides a seat 142 for the operator of the vehicle.

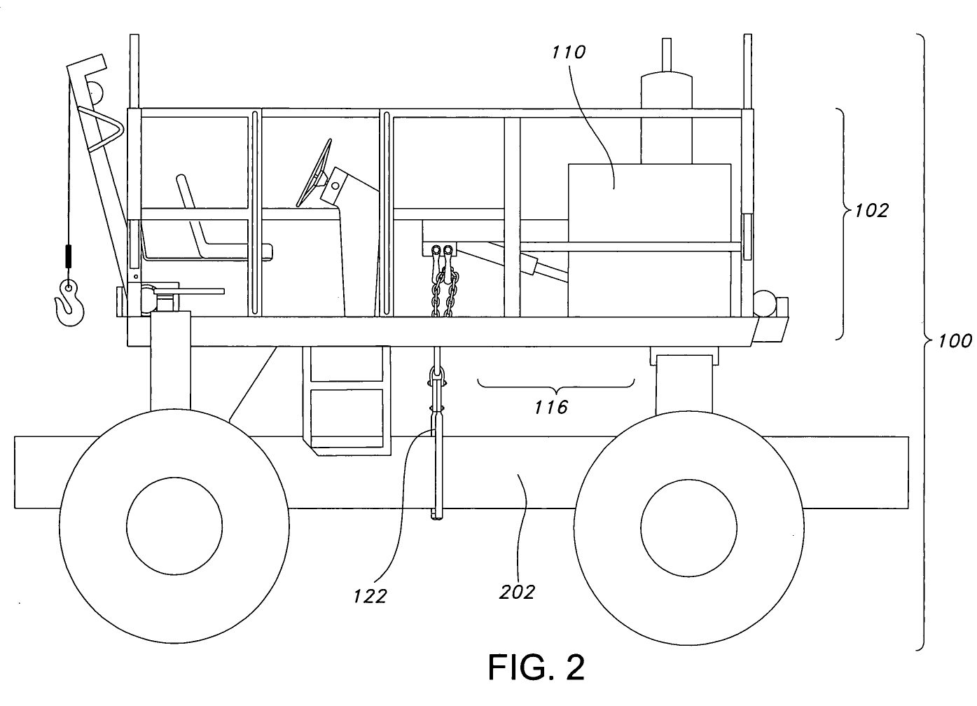

FIG. 2 shows a side view of the multipurpose all-terrain vehicle 100 with a load 202 (shown as a log) positioned and secured in the arcuate space configuration 116 beneath the elevated platform 102 supported and carried by the tongs 122. FIG. 2 is identical to FIG. 1 with the exception of the load 202. It is noted that the load may include logs, timber, building supplies, fencing, pipes, materials, and various other heavy objects. In one implementation, the load may be 36 inches in diameter and up to 24 feet in length. In another implementation, the load carrying ability may be expanded by securing a net or metal box beneath the elevated main frame platform to the center lifting boom. In this implementation, the multipurpose all-terrain vehicle can be used to safely transport cement, gravel, bricks, or other heavy, loose materials within the arcuate space configuration of the vehicle.

FIG. 3 is an anterior view of the multipurpose all-terrain vehicle 100. Referring to FIG. 3, is shown the positioning of a hydraulic pump 302 that service as a hydraulic power source for the center lifting boom 118 as well as wheeled motors 306. FIG. 3 also shows the design arches 304 which define the arcuate space configuration 116. The design arches 304 include support members 136 that are connected to the propulsion system 108. Each support member is connected together at a pivot point by a pivot pin 308, which enables each member of the arch 304 to independently move up and down when encountering uneven terrain. The pivot pin 308 may be located at the front and rear arches of vehicle 100 to permit all wheels to pivot on rough terrain. It is appreciated that other stabilization and suspension systems may be employed to enable the vehicle to maneuver on uneven terrain.

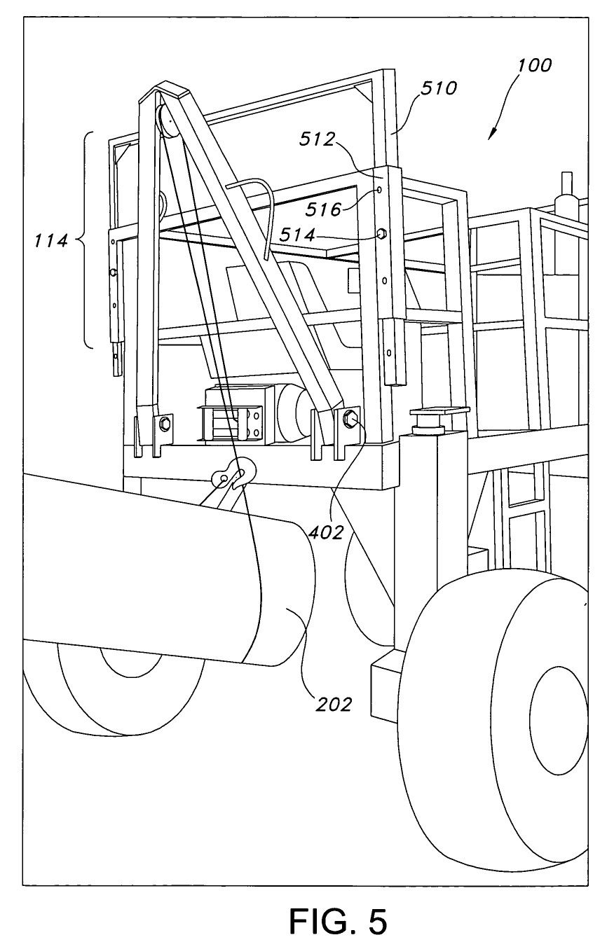

Still referring to FIG. 3 is a detailed view of the secondary height adjustable platform 114. In one implementation, the adjustable platform 114 may be raised or lowered by adjusting an anterior vertical beam 310(a) and a posterior vertical beam (shown as 510 in FIG. 5) of the interconnected frame 104. The height of the frame is increased by extending the adjustable beams 310, 510 from a hollow stationary beam 312 and is secured at a desired height with a pin 314 secured in holes 316 through the beams 310 and 312. The secondary height adjustable platform 114 may be used as portable scaffolding and is illustrated further in FIG. 9 to be described.

Still referring to FIG. 3, the vehicle's propulsion system 108 may be powered by a power source 110 and a hydraulic pump 302 which turns four separate hydraulic motors 306 attached to the tires 134 or tracks. Propulsion and turning of the tires or tracks (front and/or rear) allow the vehicle to steer.

FIG. 4 is a posterior view of the multipurpose all-terrain vehicle 100 engaged in straddling a load 202 and shows the extendable rear lifting boom 130 and rear winch 124. In one implementation the extendable rear lifting boom 130 may be removed from the vehicle by adjusting pins 402 located at the base of the boom. As shown in FIG. 4, the rear winch 124 is fully raised in an upright position and may be secured to the interconnected walls 104 by a chain, cable, or fastening mechanism not shown.

FIG. 5 is a rear perspective view of the vehicle lifting a load 202 from the rear of the vehicle 100 for transport to a truck (shown in FIG. 9) or landing (not shown). With reference to the anterior view in FIG. 3, FIG. 5 illustrates the counterpart elements of the secondary height adjustable platform 114 including the adjustable beams 510 and 512, and pins 514 and holes 516.

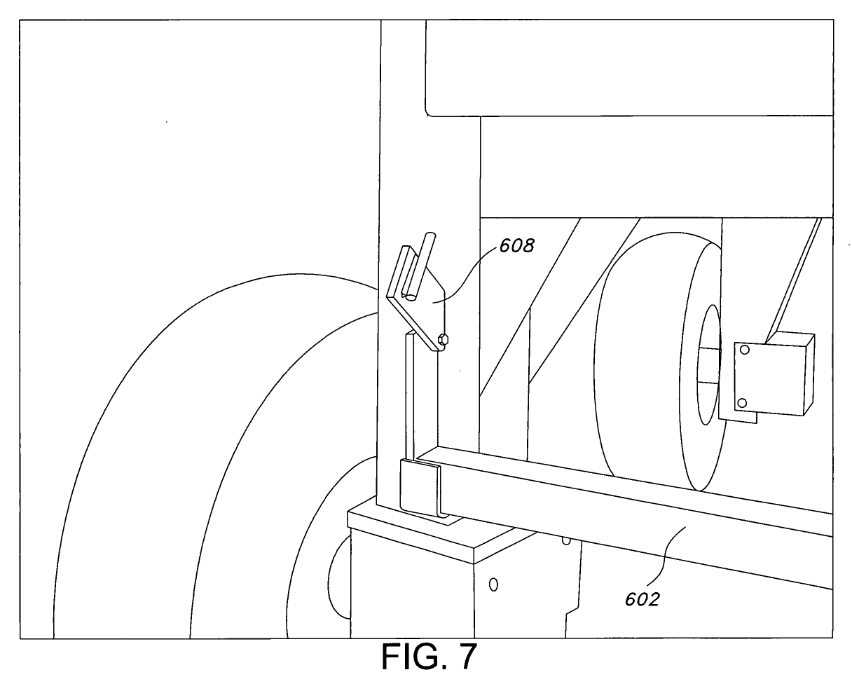

FIG. 6 shows the lower posterior end of the vehicle and the position of a removable tow bar 602 and a removable tow hitch 604. The tow hitch 604 is secured by a pin 606 and the tow bar 602 is held in position by a latch 608 connected to a member 136 over the left rear wheel motor 306. The tow hitch could also be attached to vehicle 100 by other means and at different locations of the vehicle. FIG. 7 shows the latch 608 in the open position to enable the tow bar 602 to be detached from vehicle 100. When the trailer hitch is secured to the rear of the vehicle it may be used to pull boats from water, tow a trailer, a chipper or a stump grinder.

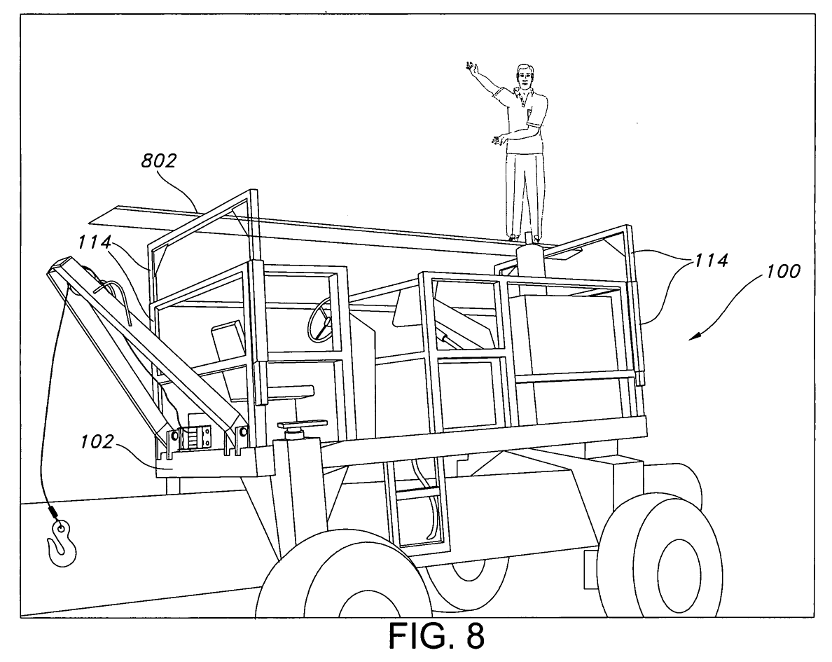

FIG. 8 is a perspective view of a vehicle 100 showing its use as a portable scaffolding 802. The scaffolding 802 rests on a secondary height adjustable platform 114 which may be integral with the elevated frame 102 or attached thereto. The secondary height adjustable platform 114 may be used as a portable scaffolding to elevate a person higher, such as for trimming and pruning trees, or be used near a house for power washing or painting, as well various other uses for a portable height adjustable scaffolding.

FIG. 9 illustrates how the extendable rear lifting boom 130 enables the vehicle 100 to lift loads 202 to different levels such as when transferring a load from the ground to a truck 902 or landing. The vehicle can transfer the load into or out of the truck 902 by causing the vehicles propulsion system 108 to move backward or forward.

FIG. 10 illustrates how the anterior winch 126 (FIG. 1) can be connected to the extendable rear lifting boom 130 via a cable 1002. In one implementation this enables the front winch 126 to control raising and lowering the extendable rear lifting boom 130 by raising or lowering cable 1002. In another implementation, the winch 124 functions to stabilize the vehicle, by shifting weight, moving the vehicle, or adding power to the vehicle. The winches 124 and 126 can be used in unison to move the vehicle without necessarily engaging the propulsion system 108. This is an extra protection feature when moving vehicle 100 over delicate terrain, or when it necessary to protect subterranean objects from being harmed by the turning of tires 134. For instance, if the vehicle 100 is on a steep incline or where there may be poor traction, it may be beneficial to attach the cables from winches 124, 126 to stationary objects and avoid potentially having the wheels skid to gather traction.

What is claimed is:

1. A multipurpose vehicle, comprising:
an elevated platform having a frame supporting a lifting system and a propulsion system;
an arcuate space configuration centered directly underneath the elevated platform, the elevated platform is supported by arches comprising the arcuate space configuration and rest on wheels comprising part of the propulsion system;
wherein the lifting system comprises a center lifting boom and second lifting mechanism, the center lifting boom is configured to lift and position a load underneath the elevated platform in the arcuate space configuration, and the second lifting mechanism is configured to engage a load from a distance, and perform at least one of the following positioning, pulling, pushing and lifting the load;
wherein the propulsion system comprises wheels individually powered such that no axles are necessary further enabling the arcuate space configuration and the ability for the vehicle to travel over all terrains and position itself directly over a load.

2. The multipurpose vehicle as recited claim 1, wherein the second lifting mechanism comprises a boom a winch and a cable.

3. The multipurpose vehicle as recited claim 1, wherein the second lifting mechanism comprises an extendable boom.

4. The multipurpose vehicle as recited in claim 1, further comprising a winch attached to at least one of the front and the rear of the vehicle configured to pull the vehicle and operate in conjunction with the second lifting mechanism.

5. The multipurpose vehicle as recited in claim 1, further comprising a secondary height adjustable platform that rests above the elevated platform to elevate a person higher than the elevated platform.

6. The multipurpose vehicle as recited in claim 1, wherein the propulsion system is powered by a power source and the propulsion system includes a hydraulic pump that powers the center lifting boom and is connected to motors attached to each of the wheels for self-propelling each wheel.

7. A multipurpose vehicle, comprising:
an elevated platform having a frame supporting a lifting system and a secondary height adjustable platform located a distance above the elevated platform, the secondary height adjustable platform supported by vertical members attached to the elevated platform, the vertical members configured to be height adjustable and to enable scaffolding to be placed on the vertical members providing the secondary height adjustable platform;
an arcuate space configuration centered directly underneath the elevated platform, the elevated platform is supported by arches comprising the arcuate space configuration and rest on wheels comprising part of the propulsion system; wherein the lifting system comprises a center lifting boom configured to lift and position a load underneath the elevated platform in the arcuate space configuration.

8. The multipurpose vehicle as recited in claim 7, further comprising arches connected to the elevated platform the arches comprising independent support members joined together by a pivot pin connected to the elevated platform, and each support member attached to a wheel at a distal end of the support members away from the pivot pin.

9. The multipurpose vehicle as recited in claim 7, further comprising a second lifting mechanism connected to the elevated platform on either end of the vehicle, the second lifting mechanism comprising an extendable boom, a winch and a cable, wherein the second lifting mechanism is used to engage a load from a distance, and perform at least one of the following positioning, pulling, pushing and lifting the load.

10. The multipurpose vehicle as recited in claim 7, further comprising a towing mechanism attached to the vehicle.

11. The multipurpose vehicle as recited in claim 7, further comprising a winch connected to either end of the vehicle.

12. The multipurpose vehicle as recited in claim 7, further comprising wheels attached to the elevated platform via support members, each wheel powered by a propulsion system.

13. The multipurpose vehicle as recited in claim 7, further comprising a lifting mechanism attached to the center lifting boom, the lifting mechanism supports a load, and wherein the combination of the lifting mechanism and center lifting boom automatically self-centers the load underneath the elevated platform in the arcuate space configuration.

14. The multipurpose vehicle as recited in claim 7, wherein the center lifting boom is powered by a hydraulic pump and includes a hydraulic piston, which causes the boom to lift up and down, wherein the lifting system further comprises a load attachment mechanism suspended from the underside of the vehicle that engages, lifts and centers the load inside the arcuate space configuration, wherein the load attachment mechanism is free moving and is able to pull a load from different angles, which further permits the load to center itself.

15. A multipurpose all-terrain vehicle able to perform a myriad of tasks on a single platform, comprising:
an elevated platform having a frame supporting a lifting system, a propulsion system, a power source, and a control mechanism, wherein centered directly underneath the elevated frame is an arcuate space configuration comprising arches that rest on a wheeled system, whereby the elevated platform in combination with the arcuate space configuration enables the vehicle to straddle, lift, and transport heavy loads underneath the elevated platform;
wherein the lifting system includes a mechanical lever includes a center lifting boom powered by hydraulic pump, the lifting boom includes a hydraulic piston, which causes the boom to lift up and down, attached to the lifting boom is a load attachment mechanism suspended from the underside of the vehicle that engages, lifts and centers the load inside the arcuate space configuration, the load attachment mechanism is free moving and is able to pull from different angles, which permit the load to center itself;
wherein the lifting system further comprises a first winch mounted on a first end of the vehicle and an extendable lifting boom and a second winch attached to a second end of the vehicle opposite the first end, wherein first winch has a cable that travels to the extendable lifting boom and is used to raise and lower the extendable lifting boom, wherein the extendable lifting boom is used to lift, pull, push, and drag loads from the vehicle, and permits the vehicle to lift loads to different levels when transferring a load from the ground to a position above the ground.

16. The multipurpose all-terrain vehicle as recited in claim 15, wherein the wheeled system is powered by at least one hydraulic motor attached to the wheeled system and enables the turning of the wheels.

17. The multipurpose all-terrain vehicle as recited in claim 15, further comprising a pivot pin to attach each arch to the elevated platform.

18. The multipurpose all-terrain vehicle as recited in claim 15, whereby the first and second winches are used to propel the vehicle.

19. The multipurpose all-terrain vehicle as recited in claim 15, further comprising a secondary height adjustable platform attached to the elevated platform, the secondary height adjustable platform is configured to support a person thereon.

20. The multipurpose all terrain vehicle as recited in claim 15, wherein the wheeled system includes all terrain tractor tires.
